(19) United States
(12) Patent Application Publication
(10) Pub. No.: US 2009/0310520 A1
(43) Pub. Date: Dec. 17, 2009

(54) WIDEBAND TELEPHONE CONFERENCE SYSTEM INTERFACE

(76) Inventors: Jun Yang, Andover, MA (US); Lonny Bowers, Burlington, CT (US)

Correspondence Address: SEYFARTH SHAW LLP, WORLD TRADE CENTER EAST, TWO SEAPORT LANE, SUITE 300, BOSTON, MA, 02210-2028, US

(21) Appl. No.: 12/139,040

(22) Filed: Jun. 13, 2008

(51) Int. Cl. H04L 12/16

(52) U.S. Cl. 370/260

(57) ABSTRACT

A telephone conferencing system interface is provided which is operable at high bandwidths via a VoIP telephone. A teleconference system interface module is connected to a the VoIP telephone via the telephone's headset connector and to a teleconference system via conferencing input circuitry, conferencing output circuitry and interface module connection circuitry. The teleconference interface module includes ground isolation transformers selected for high bandwidth operation and includes a privacy switch which can disconnect a teleconference from the VoIP telephone.

### FIELD OF THE INVENTION

The present invention relates to telecommunications and, more particularly to a system and method for interfacing a wideband telephone with a teleconferencing system.

### BACKGROUND OF THE INVENTION

In modern implementations, the majority of audio signal transmission over the public switched telephone PSTN is digital; however, signal transmission over the PSTN was originally analog in nature. Disadvantageously, analog circuits introduce random variation (i.e. noise) into the signal, and this noise increases in proportion to the distance the signal has traveled through the analog circuit. To mitigate this problem, the analog PSTN uses band pass filters to eliminate all frequencies outside the voice frequency range of about 300-3,400 Hz. This frequency range was chosen because most of the energy for intelligible speech occurs between about 0-4,000 Hz, and while the human voice can produce frequencies in the range of about 30-14,000 Hz, early telecommunications engineers determined that frequencies in the range of about 0-300 Hz and about 3,400-14,000 Hz were not necessary to understand transmitted voice signals. Advantageously, band pass filters remove signal transmission noise generated as the analog signal is amplified by network repeaters during transmission between the transmitting and receiving points, and help maintain a beneficial signal to noise ratio. This historical implementation of band pass filters that only transmit the voice frequency was maintained as the analog PSTN was converted to the pulsed code modulation (PCM) system of the digital PSTN.

The ability to accurately discern speech is influenced by the range of vocal frequencies of the human voice and the auditory range of the human ear. While the human voice can produce frequencies in the range of about 30-14,000 Hz, the human ear can typically hear frequencies in the range of about 15-20,000 Hz. Frequency spectrum analysis indicates that the fundamental frequency of the average human voice has a range between about 80-400 Hz. Disadvantageously, much of this fundamental frequency range is not included in the voice frequency transmitted over the PSTN. Generally, enough of the harmonic series in a given speech pattern will be present in the voice frequency to give the listener at the receiving point the impression of actually hearing the fundamental frequencies, even though they have been removed by the band pass filter.

The harmonic series in a speech pattern are made up of concentrations of acoustic energy around a particular frequency in a speech wave. These concentrations usually occur at 1,000 Hz intervals, and play an important role in enabling listeners to discriminate between certain consonant sounds, for example, “s and f” or “p and t” or “m and n.” Disadvantageously, band pass filters on the PSTN remove some of these frequencies which are important in allowing a listener to correctly distinguish many consonant sounds.

As digital signal processing power has increased, the ability to implement more advanced voice-compression algorithms has also increased. Consequently, telecommunications have trended toward a wideband environment, for example the use of voice over internet protocol (VoIP) in which the historical voice frequency range has been expanded. The current implementation standard for wideband voice quality is the G.722 codec, which uses an adaptive differential PCM to double the audio content within a typical 64 kbps audio data stream. While the original PCM used a 64 kbps audio data stream with a sampling rate of about 8,000 Hz, the G.722 codec doubles the sampling rate to about 16,000 Hz. Since the sampling rate corresponds to about double the highest frequency in the audio data stream, the G.722 codec expands the wideband voice frequency range to about 50-7,000 Hz.

An important aspect of telephony is that users be able to hear themselves in the earpiece of the telephone when they are speaking. This has the advantage of providing a positive feedback signal so that the user knows the telephone is working. This is usually accomplished by diverting a low level of the user's audio transmission back into the user's earpiece, and is known in the industry as sidetone. In modern telephones, sidetone is created by electronic circuitry within the phone. Disadvantageously, sidetone creates audio feedback in teleconferencing systems that leads to acoustic echo if it is not attenuated.

Existing teleconferencing systems use line echo cancellation (LEC) circuits that attenuate sidetone. A problem with prior art echo cancellation systems in existing teleconferencing systems is that they are designed for the standard 300-3,400 Hz voice frequency range associated with the PSTN, and such systems have not been developed for audio data streams that transmit in the expanded frequency range of about 50-7,000 Hz.

Another problem with prior art solutions is that traditionally a third party control method is required to initiate and control the receive level and muting functions of the microphone during a call. Disadvantageously, such third party audio equipment solutions typically mount in an equipment rack that is not accessible to the user, thereby preventing the user from easily controlling the equipment.

### SUMMARY OF THE INVENTION

The present invention provides a telephone conferencing system interface operable at high bandwidths via a VoIP telephone. A teleconference system interface module is connected to the VoIP telephone via the telephone's headset connector and to a teleconference system via conferencing input circuitry, conferencing output circuitry and interface module connection circuitry. The teleconference interface module includes ground isolation transformers selected for high bandwidth operation and includes a privacy switch which can disconnect a teleconference from the VoIP telephone.

In an illustrative embodiment, digital signal processing software removes side tone or electrical echo present on the connections. The software also provides automatic level or gain control to optimize the level. Embodiments of the invention directly connect and integrate standard corporate telephone hardware with conferencing hardware to allow user control of the conferencing hardware via the standard telephone hardware.

### BRIEF DESCRIPTION OF THE DRAWINGS

The features and advantages of the present invention will be better understood when reading the following detailed description, taken together with the following drawings in which:

FIG. 1A is an illustration of a teleconferencing system interface to a VoIP telephone in accordance with an illustrative embodiment of the present invention.

FIG. 1B is an illustration of a VoIP telephone including an integrated headset port.

FIG. 1C illustrates cable interconnection types for the VoIP and teleconferencing system interface according to the invention.

FIG. 2 is a schematic diagram of an interface module according to an illustrative embodiment of the invention;

FIG. 3 is a schematic diagram of interface module input circuitry in accordance with an illustrative embodiment of the invention;

FIG. 4 is a schematic diagram of conferencing output circuitry in accordance with an illustrative embodiment of the present invention; and

FIG. 5 is a functional block diagram of software steps for controlling mute control via in interface module in accordance with an illustrative embodiment of the present invention.

### DETAILED DESCRIPTION OF THE INVENTION

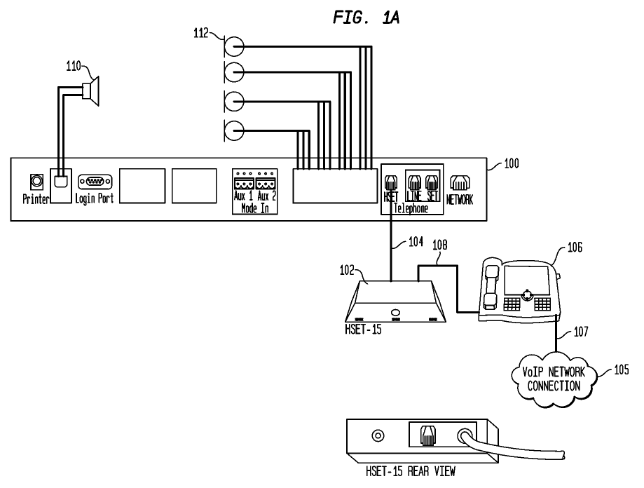

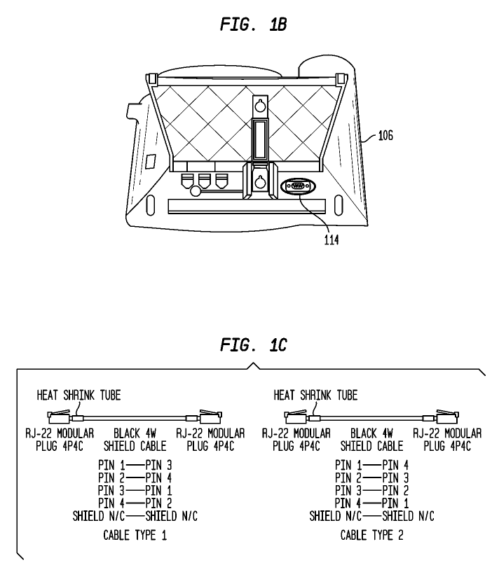

An illustrative embodiment of the invention is described with reference to FIG. 1A which illustrates a teleconference system interface to a broadband telephone such as a VoIP telephone. A teleconference system 100 such as a SimphoniX phone interface is connected to an interface module 102 via a first cable 104. An illustrative embodiment of the interface module 102 is referred to as the HSET module. Illustratively, the SimphoniX includes processor circuitry running line echo cancellation software. The interface module 102 is connected to a VoIP telephone 106 via a second cable 108. The VoIP telephone 106 may be connected to a VoIP network 105 via a third cable 107.

The teleconference system 100 is typically configured to drive a speaker 110 and receive audio signals from one or more microphones 112. FIG. 1B illustrates a standard integrated headset port 114 of the VoIP telephone 106.

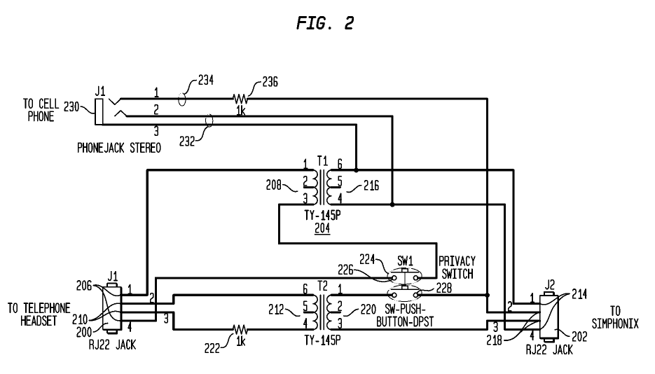

An illustrative embodiment of the interface module 102 is described with reference to the schematic diagram of FIG. 2. The interface module includes a first jack 200 adapted for connection to a headset port of a VoIP telephone such as the headset port 114 of FIG. 1B. A second jack 202 is adapted for connection to the teleconference system. Connections are made according to the cable types illustrated in FIG. 1C.

Ground isolation circuitry is electrically connected between the first jack and the second jack to prevent a direct ground connection between the first jack and the second jack. The ground isolation circuitry includes a first transformer 204 and a second transformer 206. The first jack 200 includes a first conductor pair 206 connected across a first winding 208 of the first transformer 204 and a second conductor pair 210 connected across a first winding 212 of the second transformer 206. The second jack 202 includes a third conductor pair 214 connected across a second winding 216 of the first transformer 204 and a fourth conductor pair connected across a second winding 220 of the second transformer 206.

In the interface module 102, the ground isolation circuitry may further include a first resistor 222 in series with the second conductor pair 210. The first resistor is carefully selected to in accordance with the VoIP telephone or other device connected to the first jack. In the illustrative embodiment the first transformer 204 and second transformer 206 are type TY-145P transformers manufactured by Triad Magnetics of Corona, Calif. Persons having ordinary skill in the art should understand that other transformers that are substantially equivalent to type TY-145P transformers may be used within the scope of the present invention, and that modification of the transformers may widen the frequency response of the interface module 102.

The interface module 102 may further include switching means 224 having a first pair of switch terminals 226 in series with the first conductor pair 206 and a second pair of switch terminals 228 in series with the fourth conductor pair 218. The switching means 224 are illustratively adapted to simultaneously open or close the first conductor pair 206 connection to the first winding 208 of the first transformer 204 and the fourth conductor pair 218 connection to the second winding 220 of the second transformer 206. In an illustrative embodiment of the invention, the switching means can be a double pole single throw switch, however persons having ordinary skill in the art should understand that numerous other types of switches, relays or other circuitry may provide switching means 224 to connect and disconnect the respective windings and conductor pairs.

The interface module 102 may include a third jack 230 adapted for connection to a cell phone. The third jack 230 includes a fifth conductor pair 232 connected in parallel with the third conductor pair 214 and a first conductor 234 connected in series with a second resistor 236 to a conductor of the fourth conductor pair 218. In the illustrative embodiment, both the first resistor 222 and second resistor 236 are 1K ohm resistors. Persons having ordinary skill in the art should appreciate that various other resistors may be added or substituted for the 1K ohm resistors to adjust isolation characteristics of the interface module 102 within the scope of the present invention.

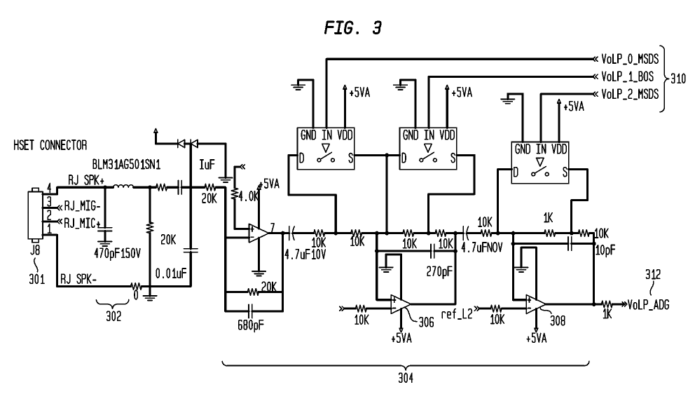

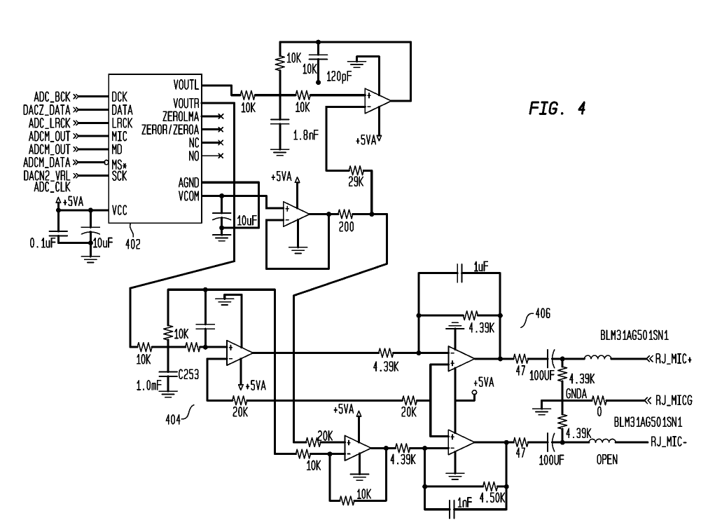

FIG. 3 is a schematic diagram of interface module input circuitry in accordance with an illustrative embodiment of the invention. The interface module interface circuitry 300 is illustratively located inside the teleconference system 100 (FIG. 1) and connected to the interface module 102 (FIG. 1) via connector 301. Impedance of the input circuitry 300 and the second transformer 206 are selected to provide a wideband frequency response. The interface module interface circuitry 300 includes a radio frequency [RF] filter portion 302 which filters radio frequency components from the interface module 102. Band pass filter circuits 304 filter out low-frequency bands and high frequency bands to improve the signal to noise ratio of the signal from the interface module 102. The signal is amplified through operational amplifiers 306 and 308 and its gain is controlled by a programmable gain amplifier [PGA] via logic pins 310. After RF filtering, band-pass filtering and amplification in the PGA circuitry, the signal from the interface module 102 is sent to analog to digital conversion (ADC) circuitry via ADC output 312 for digital sampling.

FIG. 4 is a schematic diagram of conferencing output circuitry 400 in accordance with an illustrative embodiment of the present invention. The conference output circuitry 400 converts a digital interface module output signal into an analog signal in ADC circuitry 402. The then passes the signal through band pass filter circuitry 404 to improve the signal to noise ratio and then through amplifier buffering circuitry 406. The buffering 406 circuitry is configured to expand frequency response of the second transformer 206.

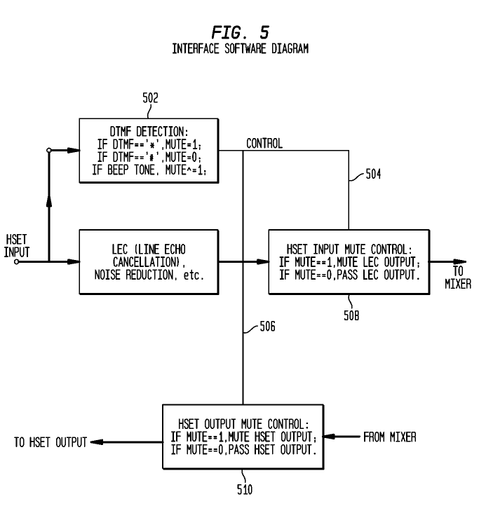

The teleconferencing system according to the invention includes echo cancellation and automatic gain control software as illustrated in FIG. 5. In a Dual-Tone Multiple-Frequency (DTMF) detection stop 502, a digital signal processor [DSP] in the teleconference system 100 performs DTMF detection to check if certain period of tones (for example, “*” or “#” or Beep tone) is received from the interface module input. Based on DTMF tone detection, a Mute” flag is set or reset. The “Mute” flag is used as a control signal 504, 506 which controls the software running on the DSP to mute or pass interface module input signals 508 and/or output signals 510. In an illustrative embodiment of the invention, the mute function can be controlled by the tone detection software steps illustrated in FIG. 5 and/or by a hardware switch such as switching means 224 of FIG. 2, for example.

Although the disclosure hereof has been stated by way of example of illustrative embodiments, it will be evident that other adaptations and modifications may be employed without departing from the spirit and scope thereof. The terms and expressions employed herein have been used as terms of description and not of limitation; and thus, there is no intent of excluding equivalents, but on the contrary it is intended to cover any and all equivalents that may be employed without departing from the spirit and scope of the invention set forth in the claims.

What is claimed is:

1. A wideband telephone conference system interface comprising:
an interface module adapted for connection between a voice over internet protocol (VoIP) telephone and a teleconference system, the interface module including a first jack adapted for connection to a headset port of said VoIP telephone, a second jack adapted for connection to said teleconference system, and ground isolation circuitry electrically connected between said first jack and said second jack to prevent a direct ground connection between said first jack and said secondjack.

2. The interface of claim 1, wherein said ground isolation circuitry includes a first transformer and a second transformer.

3. The interface of claim 2, wherein said first jack includes a first conductor pair connected across a first winding of said first transformer and a second conductor pair connected across a first winding of said second transformer, and wherein said second jack includes a third conductor pair connected across a second winding of said first transformer and a fourth conductor pair connected across a second winding of said second transformer.

4. The interface of claim 3, wherein said ground isolation circuitry further includes a first resistor in series with said second conductor pair.

5. The interface of claim 3, further comprising:
switching means having a first pair of switch terminals in series with said first conductor pair and a second pair of switch terminals in series with said fourth conductor pair, wherein said switching means are adapted to simultaneously open or close said first conductor pair connection to said first winding of said first transformer and said fourth conductor pair connection so said second winding of said second transformer.

6. The interface of claim 5 wherein said switching means comprise a double pole single throw switch.

7. The interface of claim 3 further comprising a third jack adapted for connection to a cell phone, said third jack having a fifth conductor pair connected in parallel with said third conductor pair and having a first conductor connected in series with a second resistor to a conductor of said fourth conductor pair.

8. The interface of claim 2 wherein said first transformer and said second transformer are each substantially electrically equivalent to a type TY-145P transformer.

9. The interface of claim 7 wherein said first resistor is matched to an appliance connected to said first jack.

10. The interface of claim 9 wherein said appliance is a telephone.

11. The interface of claim 7 wherein said first resistor and said second resistor are each about 1 kilo-ohm resistors.

12. The interface of claim 1 wherein said teleconference system includes interface module input circuitry including a radio frequency [RF] filter portion which filters radio frequency components from the interface module.

13. The interface of claim 12 further comprising band pass filter circuits configured to filter out low-frequency bands and high frequency bands to improve the signal to noise ratio of the signal from the interface module.

14. The interface of claim 13 further comprising programmable gain amplifier [PGA] circuitry configured to control gain of said signal filtered by said RF filter portion and said band pass filter circuits.

15. The interface of claim 14 further comprising analog to digital conversion [ADC] circuitry configured to digitally sample said signal after said signal gain is controlled by said PGA circuitry.

18. The interface of claim 1 wherein the teleconference system includes conferencing output circuitry, said conferencing output circuitry comprising digital to analog conversion circuitry adapted to converts a digital interface module output signal into an analog signal.

19. The interface of claim 18 further comprising band pass filter circuitry 404 to improve the signal to noise ratio of said analog signal.

20. The interface of claim 18 further comprising amplifier buffering circuitry to buffer said analog signal after said analog signal is filtered by said band pass filter.

21. The interface of claim 20 wherein said buffering circuitry is configured to expand frequency response of said second transformer.

22. The interface of claim 9 wherein impedance of said input circuitry and said second transformer are selected to provide a wideband frequency response.

23. The interface of claim 1 wherein said teleconference system includes conference input interface circuitry, interface module input circuitry and conferencing output circuitry each being adapted to provide a wideband frequency response.

24. The interface of claim 23 wherein said wideband frequency response is in the range of about 50 Hz to 7000 Hz.

25. The interface of claim 1 further comprising a digital signal processor programmed to provide automatic gain control, said digital signal processor in communication with said teleconference system.

26. The interface of claim 25 wherein said digital signal processor performs processing steps including:
detecting a mute control tone from the interface module;
setting/resetting a mute flag according to a detected mute control tone; and
controlling muting of a signal received from said interface module to said teleconference system in accordance with said mute flag.

27. The interface of claim 26 wherein said digital signal processor performs processing steps including:
controlling muting of a signal received from said teleconference system to said interface module.

28. The interface of claim 1 further comprising a line echo cancellation module in communication with said teleconference system.

27. A method for interfacing a VoIP telephone to a teleconference system, the method comprising:
connecting wideband isolation transformers between a headset connector of said VoIP telephone and a teleconference system;
configuring a resistor between said headset connector and said wideband isolation transformer, wherein said resistor is carefully selected to match said VoIP telephone; and
configuring a privacy switch to open or close circuitry between said wideband isolation transformer and said teleconference system.
